(19) United States
(12) Patent Application Publication
(10) Pub. No.: US 2006/0047826 A1
(43) Pub. Date: Mar. 2, 2006

(54) Client computer self health check

(75) Inventors: Daryl Carvis Cromer, Apex, NC (US); Mark Charles Davis, Durham, NC (US); Howard Jeffrey Locker, Cary, NC (US); Randall Scott Springfield, Chapel Hill, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corp., Armonk, NY (US)

(21) Appl. No.: 10/926,365

(22) Filed: Aug. 25, 2004

(51) Int. Cl. G06F 15/177; G06F 15/16

(52) U.S. Cl. 709/229; 709/220

(57) ABSTRACT

A method and system for defining every operation required of a client PC before being authorized to obtain an IP address that will enable the client PC to join a network serviced by specified DHCP servers. Each successful operation generates a value that is stored on a pre-determined location on the client PC's hard drive. A hash is created from all of the stored values, and after being encrypted, the hash is sent to the DHCP server when requesting an IP address. The DHCP server has a hash string indicative of the required status of operations that should be performed by any client PC requesting an IP address to join the network serviced by the DHCP server. If the DHCP's has string does not match with the hash sent by the client PC, then the DHCP server will not provide the requisite IP address to the client PC.

### BACKGROUND OF THE INVENTION

1. Technical Field

The present invention relates in general to the field of computers, and in particular to network based computers. Still more particularly, the present invention relates to a method and system for providing network access to only those client computers that have complied with network-determined security and policy requirements.

2. Description of the Related Art

While early personal computers (PCs) were stand-alone systems, today most PCs are connected as clients to a network. Oftentimes, this network is an enterprise-wide Local Area Network (LAN), and is often identified as a corporate network.

To connect onto the corporate network, the client PC must have an address. Most corporate networks employ the Internet Protocol (IP) to transmit data packets across the network, and thus the address used is an IP address. Typically, the IP address is not static, but rather is assigned dynamically to the client PC every time the client PC logs into the network. This IP address is typically assigned by a Dynamic Host Configuration Protocol (DHCP) server, which “leases” the IP address to the client PC.

Since a client PC is able to put data onto the corporate network, there is a risk that a user of the client PC will deliberately or inadvertently infect the corporate network with a software virus. Such viruses come in a variety of types, including viruses that attach themselves to other programs, worms that replicate and use memory but do not attach to other programs, Trojan horses (not true viruses since the don't replicate, but are still dangerous to a computer system), et al. Some of the viruses directly attack memory systems resulting in data corruption or system damage, while others can cause a Denial of Service (DoS) by repeatedly dumping large amounts of data onto the network, thus tying up the system to the point of disablement.

To protect the network from viruses and virus-like programs, networks typically rely on anti-virus programs that run locally at each node on the network. That is, typically each client PC runs a locally implemented anti-virus program that may periodically (as determined manually or automatically) scan volatile memory (e.g., system memory) and non-volatile memory (e.g., disk drives) for viruses. Such anti-virus programs can also scan incoming data/programs for harmful viruses. However, if the anti-virus program has not been recently run on a particular client PC, or if the user has for some reason run the anti-virus program but elected not to remove/disable any viruses that are present, then that client PC can infect the entire network. Additional problems arise if the virus program has not downloaded the latest version of the program that can detect the latest virus. For example, most virus programs download weekly or even more often a signature file which contains the latest virus detection and/or fix mechanisms.

Besides needing to be virus-free before logging onto a network, a client PC may also need to have implemented other security and/or policy measures, such as installing Operating System (OS) service packs, patches, encryption updates, management profiles, ensuring a latest policy compliance level, etc. For example, if a client PC has not loaded and executed the most recent OS service pack, then the OS running on the client PC may disrupt the entire network. Furthermore, if the client PC is not in legal compliance with regulations such as the access requirements of legal requirement of the Health Insurance Portability and Accountability Act (HIPAA), then a user of the client PC may be subject to legal penalties.

What is needed, therefore, is a fast method for determining that a client computer on a network has the correct and up-to-date software and policy loaded and executed before allowing that client computer to log onto the network.

### SUMMARY OF THE INVENTION

The present invention is therefore directed to a method and system for logging a client computer onto a network. When the client computer sends a request for an Internet Protocol (IP) address to a Dynamic Host Configuration Protocol (DHCP) server, a hash tag is included with the request. This hash tag describes the current state of software and policy that have been implemented on the client computer. The client's hash tag, which was included in the client's request for an IP address, is compared to a hash tag stored on the DHCP server. The hash tag stored on the DHCP server reflects the software and policies that the network requires to be implemented by any client computer wishing to log onto the network. If the client's hash tag does not match with the hash tag stored on the DHCP server, then the client computer doesn't have or hasn't properly run the requisite security software and/or is not at the right policy level. The requisite updates to software are then downloaded to the client computer. The client computer applies the updates, and creates a new hash tag. The client, now using the new hash tag, then resubmits the request for an IP address to the DHCP server. If the hash tag from the client computer still does not match the hash tag stored in the DHCP server, then the DHCP server refuses to provide an IP address to the client computer.

The above, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a network in which the present invention is operable;

FIG. 2 illustrates a block diagram of an exemplary client computer on the network;

FIGS. 3a-b depict steps taken to permit a Dynamic Host Configuration Protocol (DHCP) server to provide an Internet Protocol (IP) address to the client computer;

FIGS. 4a-b are flow charts describing the client computer receiving an IP address from the DHCP server, and

FIG. 5 is a Graphical User Interface (GUI) showing exemplary security, policy and software running in and/or applied to the client computer.

### DETAILED DESCRIPTION OF A PREFERRED EMBODIMENT

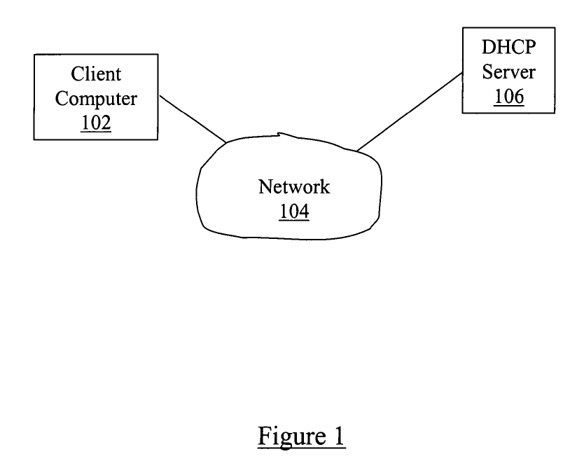

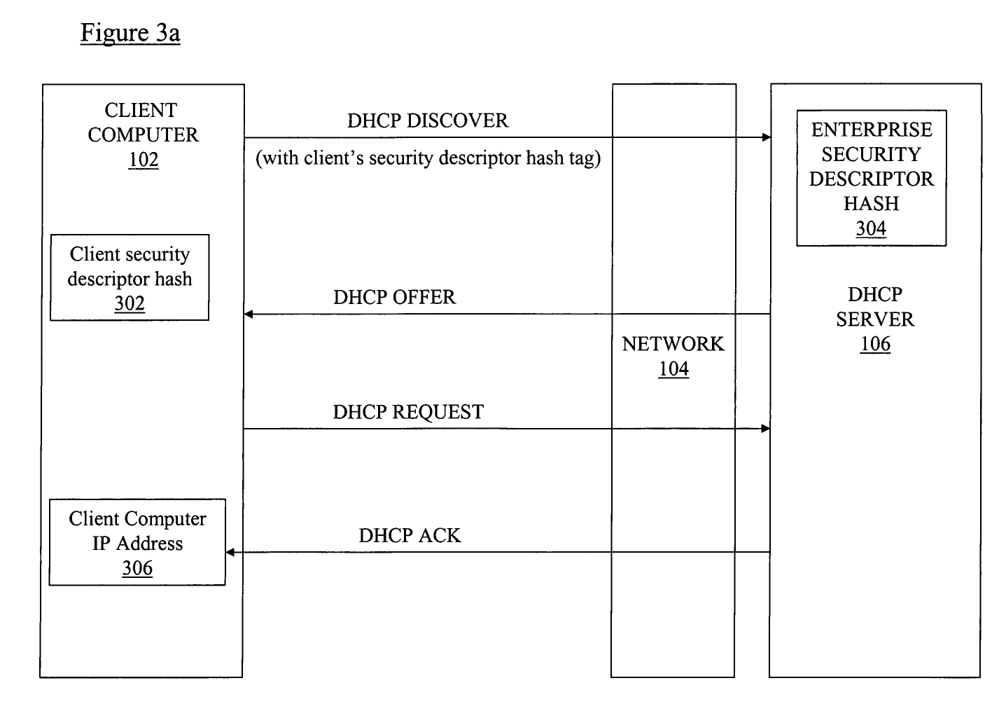

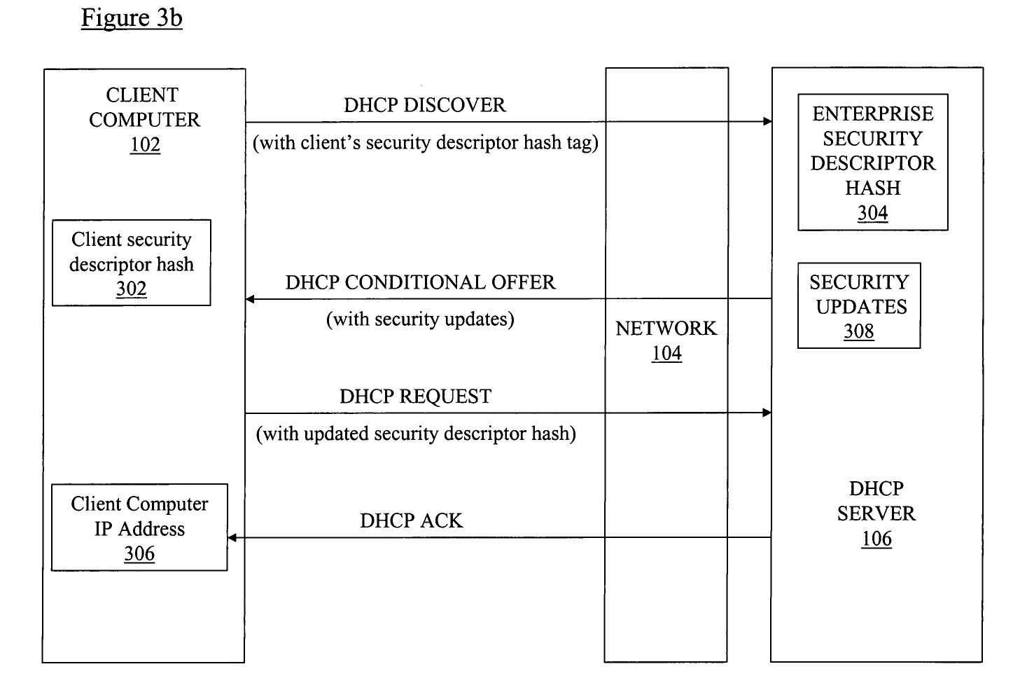

With reference now to the figures, and in particular to FIG. 1, there is depicted a block diagram of a network 104 as used by the present invention. Connected to network 104 is a client computer 102. Also connected to network 104 is a Dynamic Host Configuration Protocol (DHCP) server 106. While DHCP server 106 is shown as a single server, preferably DHCP server 106 is actually a network of DHCP servers, as discussed below in FIG. 3a.

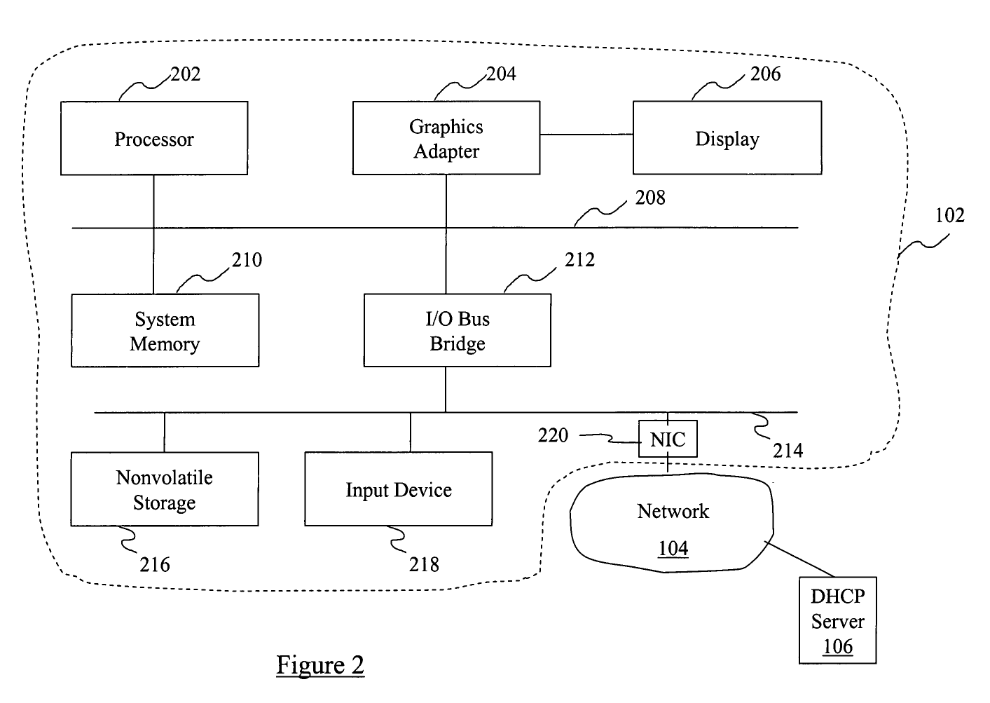

With reference now to FIG. 2, there is depicted an exemplary block diagram of client computer 102 Client computer 102 includes a processor 202, which is connected to a system bus 208. In the exemplary embodiment, client computer 102 includes a graphics adapter 204 also connected to system bus 208, receiving information for a display 206.

Also connected to system bus 208 are system memory 210 and input/output (I/O) bus bridge 212. I/O bus bridge 212 couples an I/O bus 214 to system bus 208, relaying and/or transforming data transactions from one bus to the other. Peripheral devices such as nonvolatile storage 216, which may be a hard disk drive, floppy drive, a compact disk read-only memory (CD-ROM), a digital versatile disk (DVD) drive, or the like, and an input device 218, which may include a conventional mouse, a trackball, or the like, is connected to I/O bus 214. Client computer 102 connects with network 104 via a network interface card (NIC) 220 as shown.

Network 104 may be the Internet, an enterprise confined intranet, an extranet, or any other network system known to those skilled in the art of computers. In a preferred embodiment, however, network 104 is an enterprise-wide Local Area Network (LAN) within a firewall.

The exemplary embodiment shown in FIG. 2 is provided solely for the purposes of explaining the invention and those skilled in the art will recognize that numerous variations are possible, both in form and function. For instance, client computer 102 might also include a sound card and audio speakers, memory controller, and numerous other optional components All such variations are believed to be within the spirit and scope of the present invention.

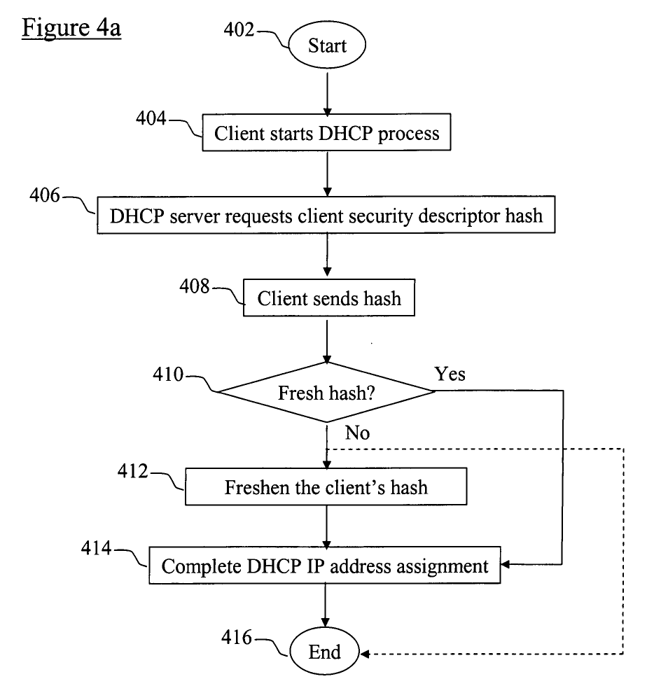

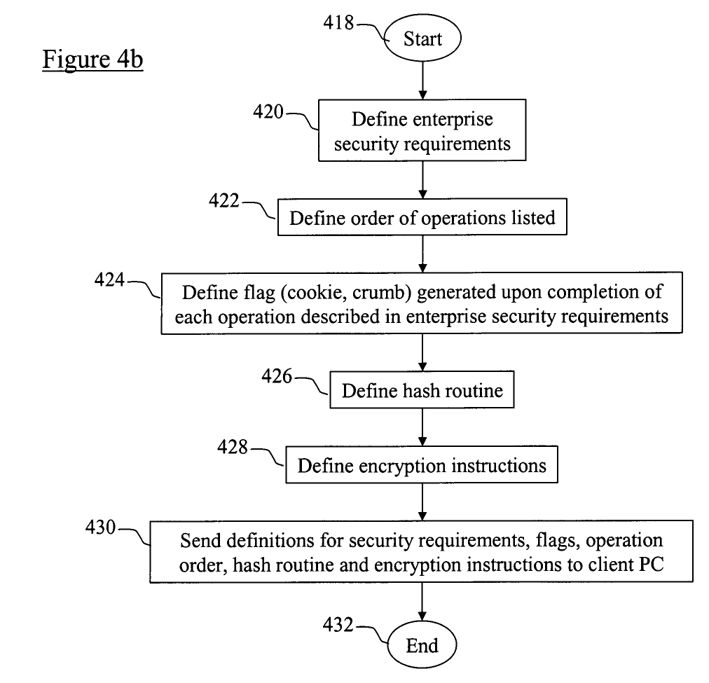

Referring now to FIG. 3, there is depicted a block diagram of steps taken by a client computer to obtain an IP address from a DHCP server in accordance with the present invention. Client computer 102 sends a DHCP DISCOVER packet to all DHCP servers connected to network 104, including DHCP server 106. DHCP server 106 examines the DHCP DISCOVER packet, which includes a client security descriptor hash 302 for client computer 102. Details of client security descriptor hash 302 are provided below with reference to FIG. 4.

DHCP server 106 compares the client security descriptor hash 302, which was attached to the DHCP DISCOVER packet, to an enterprise security descriptor hash 304. Enterprise security descriptor hash 304 is a hash of all features, including security features, required of the client computer 102 before authorization is given by the DHCP server 106 to connect to network 104. Additional details of exemplary security features so required are discussed below with reference to FIG. 4.

If the client security descriptor hash 302 and enterprise security descriptor hash 304 match, the a DHCP OFFER message is sent to client computer 102 offering an Internet Protocol (IP) address lease from DHCP server 106. Client computer 102 may receive multiple DHCP OFFER packets from different DHCP servers, and if so, then client computer 102 selects a DHCP OFFER that is preferred (offering an IP address having a preferred lease length, connection to a preferred sub-network, etc.). The client computer 102 sends a DHCP REQUEST packet to the DHCP server 106 that sent the selected DHCP OFFER packet. DHCP server 106 then responds with a DHCP ACK packet providing (leasing) a client computer IP address 306.

There may be occasions in which the client security descriptor has 302 and enterprise security descriptor hash 304 do not match because the client computer 102 does not have the latest security software, such as OS patches, anti-virus programs (and updates), etc. With reference then to FIG. 3b, if DHCP server 106 determines that the client security descriptor hash 302 does not match the enterprise security descriptor hash 304, then DHCP server 106 sends client computer 102 security updates 308 indicated by inadequate values in the client security descriptor hash 302. For example, if the client security descriptor hash 302 has a value of ABCDx01ₕₑₓ, in which the value “x” indicates that a latest required version of an anti-virus program has not been run on client computer 102, then DHCP server 106 will send that latest version of the anti-virus program to client computer 102, where it can be loaded and run. The client computer 102 then runs the received anti-virus program, and updates the client computer descriptor hash 302. Other items in security updates 308 include, but are not limited to, software patches, public encryption keys, hashing algorithms used to develop a descriptor hash, et al.

The updated client security descriptor hash 302 is then sent with the client's DHCP REQUEST packet (requesting an IP address from DHCP server 106). DHCP server 106 compares the updated security descriptor hash 302 to the enterprise security descriptor hash 304, and if they match, sends the client computer 102 the client computer IP address 306 and license in the DHCP ACK packet.

With reference now to FIG. 4a, a flowchart of preferred embodiments of the present invention is presented. After initiator block 402, a client computer starts the DHCP process (block 404). Specifically, the client computer broadcasts a DHCP DISCOVER packet requesting an IP address from a network of DHCP servers. One or more of the DHCP servers receives the DHCP DISCOVER packet, and responds (block 406) with a request for the client's security descriptor hash (if it was not already sent with the DHCP DISCOVER packet, as described above with reference to FIGS. 3a-b).

The client computer then sends its security descriptor hash (block 408) to the DHCP server. The client's security descriptor hash is defined as a hash value representing a plurality of security properties of the client computer. The hash value is a number generated from a string of security descriptive records that is substantially smaller than the records themselves. For example, consider the following records:
Anti-virus program—Norton™
Last time anti-virus program was run—within the past 24 hours
Public key used for encryption—AB28749BC293
Data access security level—HIPAA compliant
   The records indicate that the client computer has installed a Norton™ anti-virus program, and that the anti-virus program has been run within the past 24 hours; that the public key used for encrypting messages is “AB28749BC293” (which is part of a public/private key pair, in which the private key is stored in a location that is preferably accessible to the DHCP server); and that the security level for accessing data is compliant with the Health Insurance Portability and Accountability Act (HIPAA), (as described in the U.S. Federal Registry/Volume 63, No. 155/Wednesday, Aug. 12, 1998/Proporsed Rules, pages 43269 to 43271 and which is herein incorporated by reference in its entirety), including required security levels for data access control, virus checking, removal of records, data authentication, encryption, et al.

The exemplary records shown above, which each indicate security properties of the client computer, can be hashed, preferably using flags indicating a status of each of the security properties, into a single client security descriptor hash (tag), such as A93F, which is sent from the client computer to the DHCP server (as described above for block 408). In a preferred embodiment, the client security descriptor hash tag is encrypted using its public key, which is paired with a private key stored in the DHCP server, where the client security descriptor hash tag is decrypted.

Note that the records shown are exemplary and are not an exhaustive list of the types of security levels/features contemplated by the present invention. That is, the present invention contemplates in a preferred embodiment that the enterprise security descriptor hash 304 and matching client security descriptor hash 302 (shown in FIGS. 3a-b) are based on an entire protocol required by the DHCP server before authorizing an IP address license to the client computer. A preferred embodiment for how this entire protocol is defined and implemented is shown in FIG. 4b.

After initiator block 418, the enterprise security requirements for any client PC wishing to log onto a network are defined (block 420). These security requirements for the client PC wishing to join the network include, but are not limited to, what anti-virus program is loaded on the client PC, when the anti-virus program was last run on the client PC, which OS service packs are installed on the client PC, any software patches that are required to be installed on the client PC, what policy compliance levels are set on the client PC for limiting a user's ability to access and/or manipulate software (including databases and programs) on the client PC, encryption routines and passwords (or keys) used by the client PC, et. al. These defined enterprise security requirements are assigned a pre-defined order (block 422), in order to make hashing results, as described below, consistent.

Once the enterprise security requirements have been defined and ordered, a definition of an indicator of a completion or compliance status of each of the enterprise defined security requirements is made (block 424). For example, running a latest version of an anti-virus program may set a value in a pre-defined location on a hard drive (such as nonvolatile storage 216 shown in FIG. 2) in the client PC. This value, along with values generated upon the operation (and if appropriate, completion) of all other enterprise security requirements (security program execution, containing updated software, etc.) are stored in the pre-defined location of the hard drive in the pre-defined order as described in block 424.

A hash routine for the stored values (which reflect the compliance status of the enterprise security requirements) is then defined (block 426). Encryption instructions are also defined (block 428), including which encryption program is to be run, what public key is to be used, etc.

As an illustration of what a hash would then look like, consider the four records reflecting compliance status above (1. Norton anti-virus program is loaded; 2. Norton anti-virus program has been run on the client PC within the past 24 hours; 3. Public key AB28749BC293 is used for encryption; 4. The client PC is HIPAA compliant). If all of these conditions are met, then a set of condition values for the four records may be a string such as “E98Aₕₑₓ”, which is stored in a specific pre-determined location in the client PC's hard drive. (Note that although represented as a four byte value for purposes of illustration clarity, the preferred length of the hash string is actually 20 bytes long.)

Instructions and definitions for all features described in blocks 420-428 are then sent to the client PC (block 430), ending the steps at terminator block 432. Thus, each client PC now has a blueprint (based on the items shown in block 430) of what the client PC must have and do before being allowed to obtain an IP address from the DHCP server. In a preferred embodiment of the present invention, the steps described in blocks 420-428 are performed by the DHCP server.

Returning to FIG. 4a, the DHCP server then compares the sent client hash with the enterprise security descriptor hash stored in and/or accessible to the DHCP server. The enterprise security descriptor hash is a hash of the minimum security descriptors levels required for a client computer to join a network served by the DHCP server. That is, the DHCP server will identify a list of security features (such as those described above in the client computer). These security features are hashed into an enterprise security requirement hash using the same hash routine that was used above by the client computer. If, and only if, the client computer (that is requesting an IP address that will allow it to log into a specific network) has a security descriptor hash tag that matches the enterprise security descriptor hash (block 410), then the DHCP server completes the DHCP IP address assignment (block 414). Note that the query in query block 410 is for “Fresh hash,” since the client security descriptor hash must not only contain the latest security features described in the enterprise security descriptor hash, but these features (especially the anti-virus program) must have been run (installed and executed) within a recent time period that is required by the DHCP server and is represented in the enterprise security descriptor hash.

If the hash is not fresh, then the DHCP server can simply decide that the requesting client computer is not worthy of an IP address (see dashed line coming out of query block 410), and the process ends (terminator block 416). However, the DHCP server, upon recognizing that a required security level is missing, may send the client computer software required to bring the client security descriptor hash up to the DHCP server's standards (block 412). For example, the client's security descriptor hash may indicate that the client computer is still using an Operating System (OS) in which a recent security patch has not been installed. The DHCP server will send this OS patch to the client computer, thus enabling the client computer to update its security descriptor hash indicative of the OS patch having been installed. The client security descriptor hash can now be updated, and if it matches the enterprise security descriptor hash in the DHCP server, the DHCP server will send the client computer an IP address, thus completing the DHCP IP address assignment process (block 416).

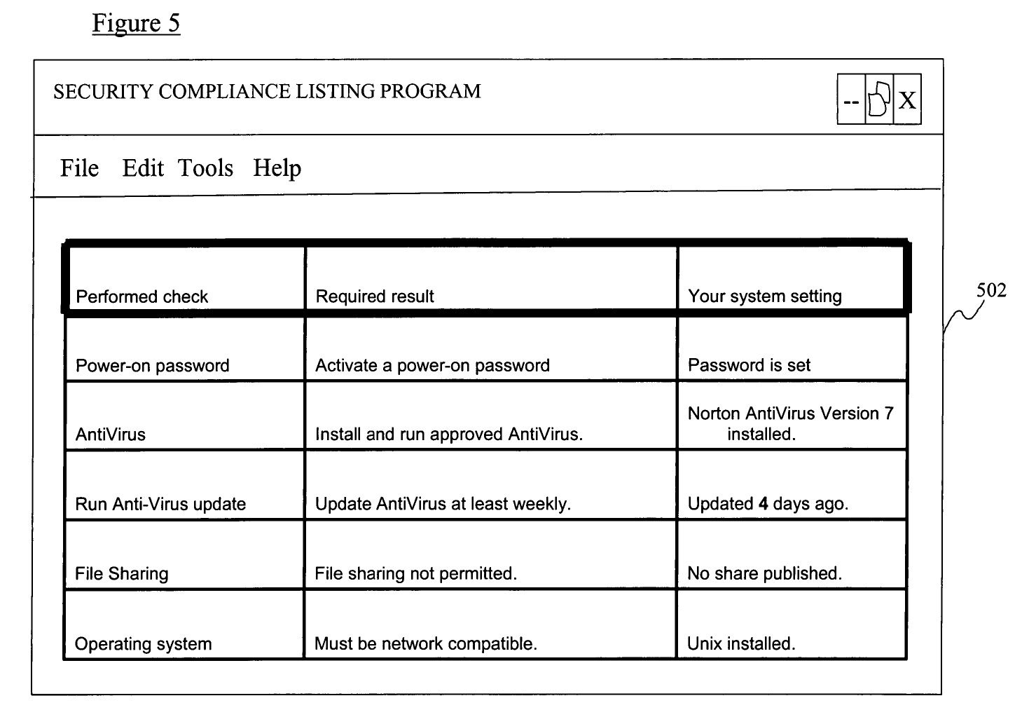

If the hash comparison described above does not provide the DHCP server with enough information to know what fixes need to be sent to the client computer, then the client computer can send, upon a request from the DHCP server, additional information regarding the security, policy and software programs of and in the client computer. For example, as shown in FIG. 5, a Graphical User Interface (GUI) 502 shows a user of the client computer what policy/software settings are currently on the client computer. If the hash sent from the client computer does not match the enterprise security descriptor hash in the DHCP server, then the DHCP server can request additional information from the client computer related to what security levels, software and policies have been applied, such as those shown in GUI 502.

In addition to the general descriptors shown in GUI 502, the client computer can send additional information regarding the security settings in the client computer. Such information may include, but not be limited to, what company wrote specific software, when the software was loaded onto the client computer, when the software was last updated, where (file pathway) the software is stored in the client computer, what type of network connector is used by the client computer, etc. Upon receiving all or some (the relevant portion) of this detailed information, the DHCP server can then send the appropriate patch/update/etc. to the client computer to put the client computer in compliance with the network's security requirements.

The present invention thus provide a method and system for defining every operation required of a client PC before being authorized to obtain an IP address that will enable the client PC to join a network serviced by specified DHCP servers. Each successful operation generates a value that is stored on a pre-determined location on the client PC's hard drive. A hash is created from all of the stored values, and after encryption, the hash is sent to the DHCP server when requesting an IP address. The DHCP server has a hash string indicative of the required status of operations that should be performed by any client PC requesting an IP address to join the network serviced by the DHCP server. If the DHCP's has string does not match with the hash send by the client PC, then the DHCP server will not provide the requisite IP address to the client PC.

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media, or USB storage devices), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A method comprising:
coupling a server to a network;
defining a plurality of security requirements required to be implanted by a client computer before the client computer is authorized to log onto the network;
receiving at the server a request for a network address from the client computer, the network address enabling the client computer to log onto the network, the request for the network address including a security descriptor tag that describes a status of compliance, by the client computer, with the required security requirements;
comparing the security descriptor tag to a network security descriptor, the network security descriptor describing the status of compliance with the security requirements that is required for the client computer to log onto the network; and
providing the client computer the requested network address only if the security descriptor tag matches the network security descriptor.

2. The method of claim 1, wherein the network address is an Internet Protocol (IP) address, and wherein the server is a Dynamic Host Configuration Protocol (DHCP) server.

3. The method of claim 1, wherein the status of compliance, by the client computer, with the required security requirements is represented by a string of data stored in a predetermined location in a non-volatile memory in the client computer.

4. The method of claim 3, further comprising:
hashing the string of data representing the status of compliance by the client computer, such that the security descriptor tag is a client security descriptor hash;
hashing the network security descriptor to create an enterprise security descriptor hash;
comparing the client security descriptor hash to the enterprise security descriptor hash; and
providing the client computer with the requested IP address only if the client security descriptor hash matches the enterprise security descriptor hash.

5. The method of claim 4, further comprising:
in response to hashed string of data from the client computer not matching the enterprise security descriptor hash, sending at least a portion of a detailed descriptor describing the status of compliance in the client computer.

6. The method of claim 1, wherein the security descriptor tag is based on when the client computer last ran an anti-virus program.

7. The method of claim 1, wherein the security descriptor tag is based on whether the client computer has adequate data access protection to prevent unauthorized data access of data on the client computer.

8. The method of claim 7, wherein the adequate data access protection is compliant with the Health Insurance Portability and Accountability Act (HIPAA).

9. The method of claim 1, wherein the security descriptor tag is based on whether the client computer has executed all Operating System (OS) patches required by the server.

10. The method of claim 1, wherein the security descriptor tag is based on whether the client computer has a first encryption key that matches a second key in a key pair, the second key being stored in the server.

11. The method of claim 1, wherein the security descriptor tag is based on whether the client computer has downloaded and executed all patches identified by the server as being required to communicate with the network.

12. The method of claim 1, further comprising:
in response to the security descriptor tag not matching the network security descriptor, sending from the client computer to the server a non-hashed listing of software and security settings currently in the client computer, the software and security settings having been previously hashed by the client computer to create the client computer's security descriptor tag; and
in response to receiving the non-hashed listing at the server, sending from the server to the client computer any required corrective software that, when run, places the client computer in compliance with the network's security requirements, thus resulting in a security descriptor tag that matches the network security descriptor.

13. A computer program product, residing on a computer usable medium, the computer program product comprising:
program code for coupling a server to a network;
program code for defining a plurality of security requirements required to be implanted by a client computer before the client computer is authorized to log onto the network;
program code for receiving at the server a request for a network address from the client computer, the network address enabling the client computer to log onto the network, the request for the network address including a security descriptor tag that describes a status of compliance, by the client computer, with the required security requirements;
program code for comparing the security descriptor tag to a network security descriptor, the network security descriptor describing the status of compliance with the security requirements that is required for the client computer to log onto the network; and
program code for providing the client computer the requested network address only if the security descriptor tag matches the network security descriptor.

14. The computer program product of claim 13, wherein the network address is an Internet Protocol (IP) address, and wherein the server is a Dynamic Host Configuration Protocol (DHCP) server.

15. The computer program product of claim 13, wherein the status of compliance, by the client computer, with the required security requirements is represented by a string of data stored in a predetermined location in a non-volatile memory in the client computer.

16. The computer program product of claim 15, further comprising:
program code for hashing the string of data representing the status of compliance by the client computer, such that the security descriptor tag is a client security descriptor hash;
program code for hashing the network security descriptor to create an enterprise security descriptor hash;
program code for comparing the client security descriptor hash to the enterprise security descriptor hash; and
program code for providing the client computer with the requested IP address only if the client security descriptor hash matches the enterprise security descriptor hash.

17. The computer program product of claim 13, further comprising:
program code for, in response to the security descriptor tag not matching the network security descriptor, sending from the client computer to the server a non-hashed listing of software and security settings currently in the client computer, the software and security settings having been previously hashed by the client computer to create the client computer's security descriptor tag; and
program code for, in response to receiving the non-hashed listing at the server, sending from the server to the client computer any required corrective software that, when run, places the client computer in compliance with the network's security requirements, thus resulting in a security descriptor tag that matches the network security descriptor.

18. A system comprising:
a server coupled to a network;
a network interface in the server for receiving at the server a request for a network address from a client computer, the network address enabling the client computer to log onto the network, the request for the network address including a security descriptor tag that describes a current security level of the client computer;
a comparator in the server for comparing the security descriptor tag to a network security descriptor, the network security descriptor describing a current security level required by the network to allow the client computer to log onto the network; and
an address provider in the server for providing the client computer the requested network address only if the security descriptor tag matches the network security descriptor.

19. The system of claim 18, wherein the network address is an Internet Protocol (IP) address, and wherein the server is a Dynamic Host Configuration Protocol (DHCP) server, and wherein the security descriptor tag is a hash value representing a plurality of security properties of the client computer.

20. The system of claim 19, wherein the security descriptor tag is a hashed string describing a pre-determined order of the plurality of security requirements required for the client computer to log onto the network, and wherein the network security descriptor is a hashed string describing the status of compliance with the security requirements that is required for the client computer to log onto the network.
